(19) United States
(12) Patent Application Publication
(10) Pub. No.: US 2008/0263962 A1
(43) Pub. Date: Oct. 30, 2008

(54) DOOR GAP GUARD

(76) Inventor: Shao-Tsung WEI, Taipei Hsien (TW)

Correspondence Address: LEONG C LEI, PMB # 1008, 1867 YGNACIO VALLEY ROAD, WALNUT CREEK, CA, 94598, US

(21) Appl. No.: 11/740,291

(22) Filed: Apr. 26, 2007

(51) Int. Cl. B60J 5/00

(52) U.S. Cl. 49/462

(57) ABSTRACT

Disclosed is a door gap guard made of a reilient material is disclosed having an elongated center portion, a longitudinal strip of mounting portion connected to one side of the elongated center portion and affixed to the doorframe, and a narrow elongated motion portion connected to an opposite side of the elongated center portion with the free end disposed in contact with the door panel to cover the gap between the doorframe and a door panel and to avoid finger crush accidents.

### BACKGROUND OF THE INVENTION

(a) Technical Field of the Invention

The present invention relates to a protection device and more particularly, to a door gap guard, which eliminates painful finger trapping accidents on the hinge side of a door.

(b)Description of the Prior Art

When a door in the open position,a gap is created on the hinge side of the door. A finger crudh accident may occur at this time if a child inserts the fingers into the gap between the door panel and the doorframe. According statistics from every local firefighting department, many children seriously crush their fingers in doors every year. Therefore, a gap between the doorframe and the door panel has to be shielded to prevent finger crush accidents.To avoid finger crush accidents in doors, the door gap must be shielded.

### SUMMARY OF THE INVENTION

The primary purpose of the present invention is to provide a door gap guard,which covers the gap between the doorframe and the door panel, avoiding finger crush accidents. According to one aspect of the present invention, the door gap guard is made of a resilient material,comprising an elongated center portion,a longitudinal strip of mounting portion connected to one side of the elongated motion portion connected to an opposite side of the elongated center portion with the free end disposed in contact with the door panel to cover the gap between the doorframe and a door panel and to avoid finger crush accidents.

According to another aspect of the present invention, the elongated center portion is formed of a torsional spring.

According to still another aspect of the present invention, the door gap guard further comprises a rod-like free end portion longitudinally connected to one side of the narrow elongated motion portion elongated center portion. According to still another aspect of the present invention, the door gap guard further comprises a curved portion longitudinally connected between the narrow elongated motion portion and the rod-like free end portion.

According to still another aspect of the present invention, the narrow elongated motion portion has a transverse width greater that the longitudinal strip of mourning portion.

The foregoing object and summary provide only a brief introduction to the present invention. To fully appreciate these and other objects of the present invention as well as the invention itself, all of which will become apparent to those skilled in the art, the following detailed description of the invention and the claim should be read in conjunction with the accompanying drawings. Throughout the specification and drawings identical reference numerals refer to identical or similar parts.

Many othe radvantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG.1 illustrates a door gap guard in accordance with a first embodiment of the present invention.

FIG.2 illustrates a door gap guard in accordance with a second embodiment of the present invention.

FIG.3 is an applied view of the present invention,showing the door gap guard installed in a door between the doorframe and the door panel.

FIG.4 is a top view in an enlarged scale FIG.3.

FIG.5 corresponds to FIG.3 showing the door panel opened to 90°.

FIG.6 is a top view in an enlarged scale of FIG.5.

FIG.7 corresponds to FIG.3 showing the door panel opened to 180°.

FIG.8 is a top view in an enlarged scale of FIG.7.

### DETAILED DESCRIPTION OF THE PREFERRED EMBODIMENTS

The following descriptions are of exemplary embodiments only,and are not intended to limit the scope,applicability or configuration of the invention in any way. Rather,the following description provides a convenient illustration for implementing exemplary embodiments of the invention. various changes to the described embodiments may be made in the function and arranegment of the elements described without departing from the scope of the invention as set forth in the appended claims.

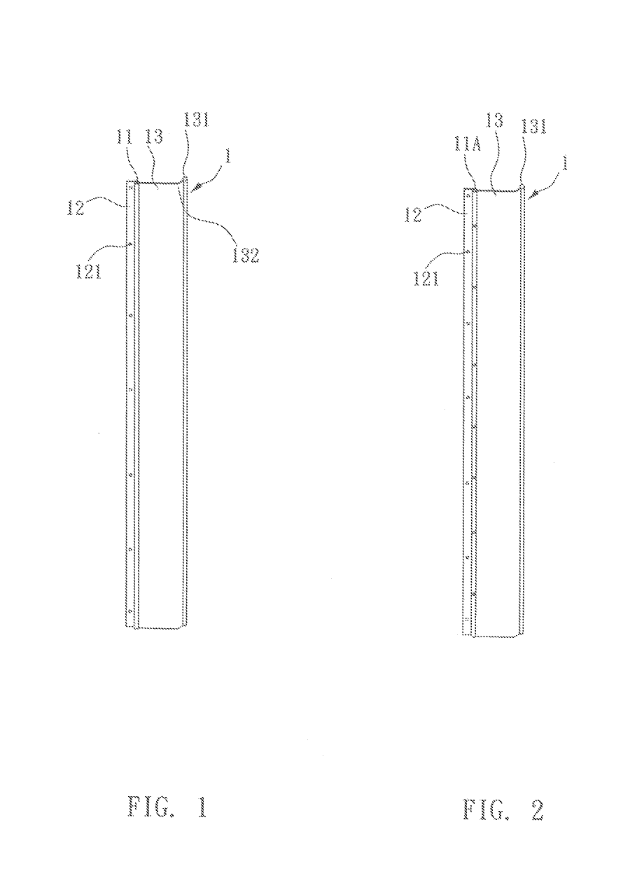

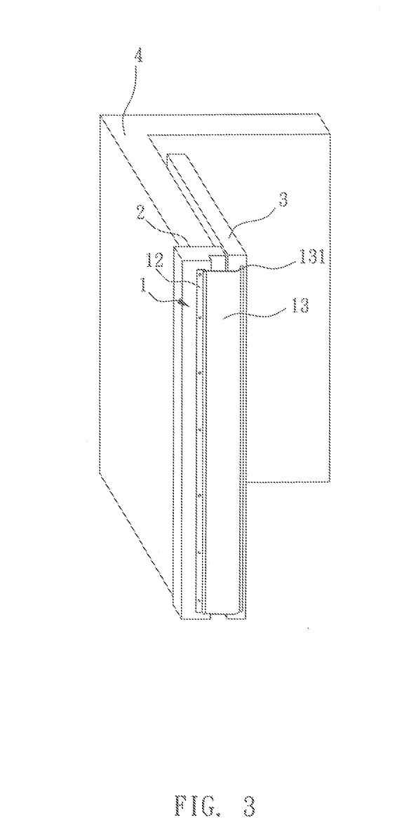

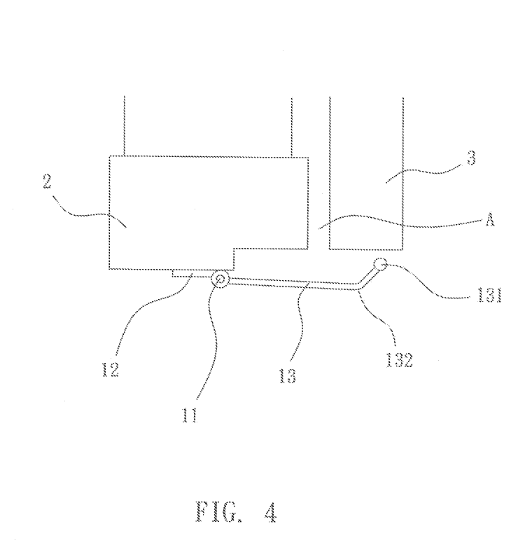

Referring to FIGS.1, 3 and 4, a door gap guard in accordance with a first embodiment of the present invention is a narrow elongated thin sheer member. The door gap guard may be made integrity from steel,plastics,reinforced plastics,or any other material that has sufficient ridgity and resiliency. The door gap guard comprises a flat motion portion 13 longitudinally disposed on the middle, a rod-like free end portion 131 longitudinally disposed at one side in paralell to hte flat motion portion 13, a curved portion 132 longitudinally connected between the flat motion portion 13 and the rod-like free end portion 131, a longitudinal strip of mounting portion 12 longitudinally disposed at an opposite side in paralell to the flat motion portion 13, a plurality of mounting holes 121 cut through two opposite sides of the longitudinal strip of mounting portion 12 and arranged in line along the length of the longitudinal strip of mounting portion 12, and a center portion 11 extending along the length of the flat motion portion 13 and the longitudinal strip of mounting portion 12 and connected between the flat motion portion 13 and the longitudinal strip of mounting portion 12. The flat motion portion 13 has a transverse width much greater than the longitudinal strip of mounting portion 12. Screws are mounted in the mounting holes 121 to affix the longitudinal strip of mounting portion 12 to the doorframe 2 at the wall 4 (see FIGS.3 and 4). When the door panel 3 is fully opened, as shown in FIG.3, the rod-like free end portion 131 is kept in close contact with the inner lateral side edge of the door panel 3 to cover the gap between the doorframe 2 and the door panel 3.

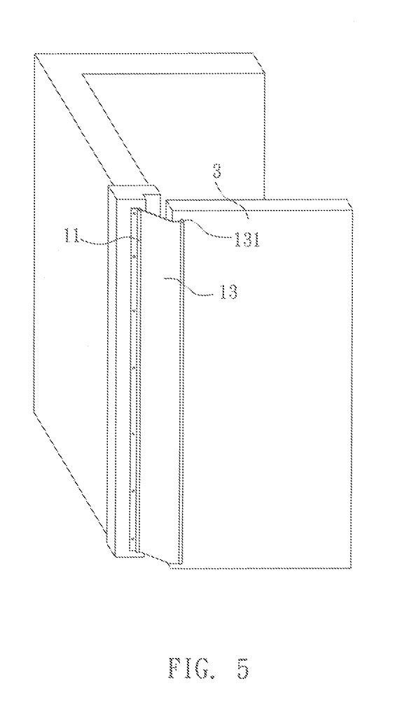

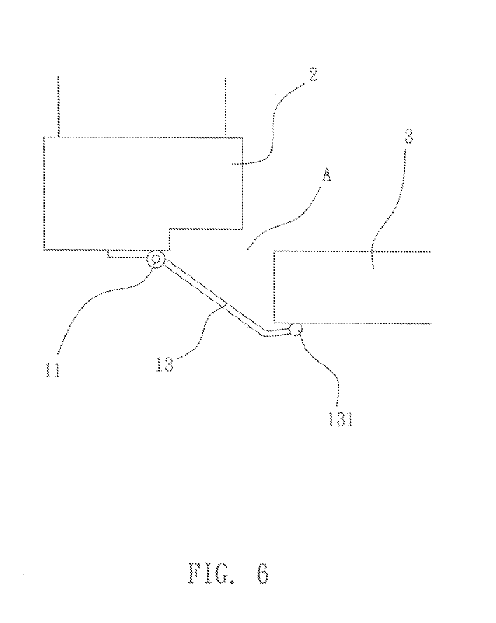

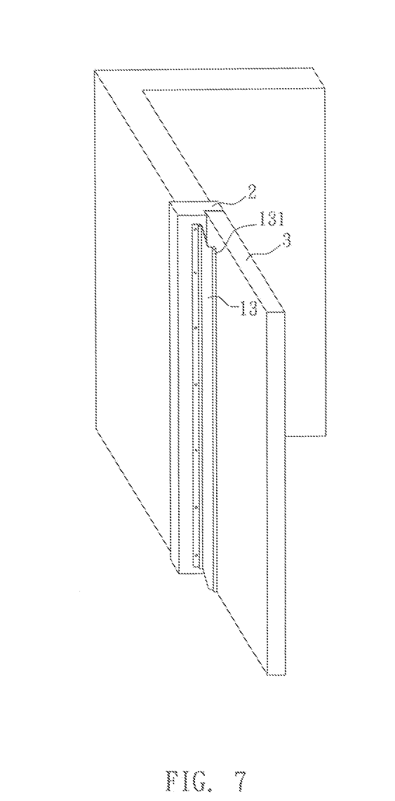

Referring to FIGS. 5-8,when the door panel 3 is turned to the 90o angle position (see FIGS.5 and 6),the rod-like free end portion 131 is moved from the inner lateral side edge of the door panel 3 to the outer side of the door panel 3 and kept in close contact with the outer surface of the door panel 3, covering the gap A between the doorframe 2 and the door panel 3; when the door panel 3 is turned to the fully close position (see FIGS.7 and 8),the flat motion portion 13 is forced to deform by the pressure from the door panel 3 to reserve spring power that will force the rod-like free end portion 131 toward and into contact with the door panel 3 when the door panel 3 is opened again. FIG.2 shows a door gap guard in accordance with a second embodiment of the present invention. This embodiment is substantially similar to the aforesaid first embodiment with the exception of the use of a torsional spring 11A to substitute the aforesaid center portion 11. This second embodiment achieves the same effect of the aforesaid first embodiments to avoid finger crush accidents. In addition to the effect of avoiding finger crush accidents,the door gap guard imparts a damping resistance to the door panel to prevent a sudden closing action of the door panel.

A prototype of door gap guard has been contructed with the features of FIGS.1-8. The door gap guard functions amoothly to provide all of the features disclosed earlier.

Although particular embodiments of the invention have been described in detail for purposes of illustration,various modifications and enhancements may be made without departing from the spirit and scope of the invention. Accordingly, the invention is not to be limited except as by the appended claims.

It will be understood that each of the elements described above,or two or more together may also find a useful application in other types of methods differing from the type described above.

While certain novel features of this invention have been shown and described and are pointed out in the annexed claim, it is not intended to be limited to the details above, since it will be understood that various omissions, modifications,substitutions and changes in the forms and details of the device illustrated and in its operation can be made by those skilled in the art without departing in any way from the spirit of the present invention.

I claim:

1. A door gap guard made of a resilient material,comprising:
an elongated center portion;
a longitudinal strip of mounting portion connected to one side of said elongated center portion and affixed to a doorframe;and
a narrow elongated motion portion connected to an opposite side of said elongated center portion for covering the gap between said doorframe and a door panel being hinged to said doorframe.

2. The door gap guard as claimed in claim 1,wherein said elongated center portion is formed of a torional spring.

3. The door gap guard as claimed in claim 1, further comprising a rod-like free end portion longitudinally connected to one side of said narrow elongated motion portion elongated center portion.

4. The door gap guard as claimes in claim 3,further comprising a curved portion longitudinally connected between said narrow elongated motion portion and said rod-like free end portion.

5. The door gap guard as claimed in claim 3, wherein said narrow elongated motion portion has a transverse width greater than said longitudinal strip of mounting portion.
